(19) United States
(12) Patent Application Publication
(10) Pub. No.: US 2022/0380060 A1
(43) Pub. Date: Dec. 1, 2022

(54) VARIABLE MIXING NOZZLE DESIGN FOR JET NOISE REDUCTION

(71) Applicant: United States of America as representedby the Administrator of NASA, Washington, DC (US)

(72) Inventor: Jonathan M. Burt, Cleveland, OH (US)

(21) Appl. No.: 17/804,636

(22) Filed: May 31, 2022

Related U.S. Application Data
(60) Provisional application No. 63/194,544, filed on May 28, 2021.

(51) Int. Cl. F02K 1/34; F02K 1/82; F02K 1/38

(52) U.S. Cl. CPC B64D 33/06; F02K 1/827; F02K 1/386

(57) ABSTRACT

An engine exhaust nozzle for a jet engine offers a controllable variable mixing of engine exhaust and the surrounding airflow. The engine exhaust nozzle includes a nozzle, slots at the downstream end of the nozzle, curved vanes extending radially inward from the inner surface of the nozzle and adjacent to the slots, and a cover connected to the outside of the nozzle and movable with respect to the nozzle so as to open and close the slots. When the slots are opened, near-field mixing is enhanced between the jet exhaust and the surrounding air, thus reducing mixing further downstream and the noise associated therewith, thus reducing the overall noise transmitted to the ground. When the slots are closed, the nozzle propulsive efficiency improves at the expense of increased noise.

### CROSS REFERENCE TO RELATED APPLICATION

This application claims priority to U.S. Provisional Patent Application Ser. No. 63/194,544 filed May 28, 2021, which is expressly incorporated herein by reference.

### ORIGIN OF THE INVENTION

The invention described herein was made by employees of the United States Government and may be manufactured and used by or for the Government for Government purposes without the payment of any royalties thereon or therefor.

### BACKGROUND

Jet engines on aircraft tend to produce high levels of noise during operation. While this might not be a concern at high altitudes, it can lead to community noise concerns during low-altitude flight. In particular, jet noise during takeoff and initial climb is a dominant contributor to airport noise. This noise source is a particular concern in the development of commercial supersonic transport concepts, for which significant jet noise reduction may be required for compliance with international aircraft noise regulations.

Various strategies have been employed to curb the noise emanating from jet engines. In addition to the widespread use of high bypass ratios for turbofan engines on subsonic commercial aircraft, existing jet noise reduction strategies include chevrons, lobed mixers, mixer-ejector nozzles, multi-stream nozzles, thermal acoustic shields and other gas injection configurations. Any of these strategies may be used independently or in combination with over-wing or over-tail engine mounting for mechanical shielding. These strategies usually involve a tradeoff between power, noise, and mechanical complexity of the means employed for noise reduction. Although most of these strategies have been demonstrated to provide some noise reduction, they all represent a balance between engine efficiency and complexity of the noise reducing means, and thus many are subject to significant penalties in added weight, complexity, and/or reduced thrust. More specifically, nozzle modifications for jet noise reduction typically have multiple moving parts or auxiliary gas sources, or they suffer from significant thrust loss during cruise and other flight phases where the desire for high propulsive efficiency outweighs the desire for improved acoustics. In order to satisfy noise regulations, a designer usually chooses between increased design complexity of the noise reduction mean on the one hand, and reduced cruise efficiency of the jet engine on the other hand.

For example, high-penetration chevron nozzles are known to be effective for noise reduction during takeoff and low-altitude climb but tend to significantly reduce propulsive efficiency during supersonic cruise. In order to avoid unacceptable cruise efficiency loss, the designer may therefore opt for variable geometry chevrons with adjustable penetration. However, the required chevron mechanization and actuation introduces dozens of moving parts, and resulting penalties in weight, reliability and maintenance costs are expected. The use of complex variable geometry is especially problematic around a jet nozzle, where exposure to high-temperature exhaust gases can create problems related to thermal management and thermal expansion at joints or linkages.

### SUMMARY

In one aspect, an engine exhaust nozzle includes a nozzle; slots arranged at a downstream end of the nozzle, each of the slots extending completely through a thickness of the nozzle from an inner surface of the nozzle to an outer surface of the nozzle; and vanes on the inner surface of the nozzle, each of the vanes being arranged at an edge of a respective one of the slots, extending in length along the edge, and projecting from the inner surface towards a central axis of the nozzle. The engine exhaust nozzle may also include a cover connected to the nozzle and movable with respect to the nozzle between a first position in which the cover does not cover the slots such that the slots are open, and a second position in which the cover covers the slots such that the slots are closed.

In another aspect, a jet engine includes the engine exhaust nozzle, which ejects exhaust from the jet engine.

In another aspect, an aircraft includes the jet engine, and the jet engine is attached to a fuselage, a tail, or a wing of the aircraft.

In another aspect, a method of operating the aircraft includes operating the jet engine in a first state in which the cover is in the first position and the slots are open; moving the cover between the first position and the second position; and operating the jet engine in a second state in which the cover is in the second position and the slots are closed.

In another aspect, a method of making a jet engine includes attaching the engine exhaust nozzle to the jet engine.

In another aspect, a method of making an aircraft includes attaching the jet engine to the aircraft.

### BRIEF DESCRIPTION OF THE DRAWINGS

FIG. 1 is a perspective view of an engine exhaust nozzle in a first state according to the present subject matter.

FIG. 2 is a perspective view of an engine exhaust nozzle in a second state according to the present subject matter.

FIG. 3 is a perspective view of a cover according to the present subject matter.

FIG. 4 is a perspective view of a nozzle according to the present subject matter.

FIG. 5 is a perspective view of a nozzle according to the present subject matter.

### DETAILED DESCRIPTION

The present subject matter provides an engine exhaust nozzle 2 including a nozzle 4, a series of vanes 6 and corresponding slots 8. The engine exhaust nozzle 2 can be used on a jet engine of an aircraft to control a flow of exhaust gases exiting the jet engine.

The engine and aircraft on which the engine exhaust nozzle 2 is employed are not particularly limited, and may include turbofan engines, turbojet engines, afterburning turbojet engines, turboprop engines, ramjet engines, turboshaft engines, or supersonic jet engines and aircraft, such as airplanes, including the same. The engine exhaust nozzle 2 is used to eject engine exhaust, e.g., in the form of jet blast or jet efflux, from the engine. The engine, e.g., a jet engine, can be attached to a wing of the aircraft, to the fuselage or tail of the aircraft, or to another component of the aircraft.

The nozzle 4 is not particularly limited and can be similar to an existing circular convergent nozzle or plug nozzle. Various nozzle types can be employed as the nozzle 4. The nozzle 4 is a wall defining an inner surface 10, an outer surface 12, an upstream end including an upstream edge 14, a downstream end including a downstream edge 16, a thickness measured between the inner surface 10 and the outer surface 12, a length measured between the upstream edge 14 and the downstream edge 16, a central axis 18 extending along its length, and a diameter measured from the central axis 18 to the wall. The nozzle 4 can be the shape of a circle (annular), oval, square, rectangle, or other shape. In one non-limiting example, the nozzle 4 has a circular shape as depicted in the figures with a generally decreasing diameter going from the upstream edge 14 to the downstream edge 16.

The vanes 6 are arranged circumferentially around the inner surface 10 of the nozzle 4 at the downstream end of the nozzle near or at the downstream edge 16 of the nozzle 4 and extend/project radially inward in height from the inner surface 10 toward the central axis 18. The vanes 6 are fixed vane-type vortex generators that are circumferentially spaced from each other, and optionally evenly circumferentially spaced from each other, i.e., evenly spaced around a circumference of the nozzle 4. The vanes 6 may be arranged directly at the downstream edge 16, or at a small distance upstream (i.e., toward the upstream edge 14) from the downstream edge 16.

Each vane 6 includes a root 20, a tip 22, a leading edge 24, a trailing edge 26, two circumferentially opposite side surfaces (a clockwise side surface 28 facing the clockwise direction in the figures, and a counterclockwise side surface 30 facing counterclockwise in the figures), a height measured between the root 20 and the tip 22, a length measured along the root 20 between an upstream end (where the leading edge 24 meets the root 20) and a downstream end (where the trailing edge 26 meets the root 20), and a thickness measured between the two side surfaces 28, 30.

The root 20 may run in an approximate straight line parallel to the central axis 18, i.e., within a radial plane through the central axis 18. This straight line may be the interface between the nozzle 4 and one of the side surfaces 28, 30 of the vane 6.

The length and height of each vane 6 may be greater than its thickness. Each vane 6 has a height that is large enough so as to extend outside a nozzle wall boundary layer. The root 20 is attached to the inner surface 10 of the nozzle 4, and the tip 22 is free from direct attachment. Each vane 6 may have a general triangle shape, with the leading edge 24 of each vane 6 having a general positive slope going along its length in a direction from the upstream end to the downstream end as depicted in the figures. The vanes 6 may have other shapes.

Each vane 6 may be curved from the root 20 to the tip 22 along its height in a circumferential direction, so that the vane 6 extends over a respective one of the slots 8 to which the vane 6 is adjacent. In other words, the vane 6 may be curved such that, in a radially inward direction toward the central axis 18, the vane 6 at least partially covers the respective slot 8 by being arranged over the slot 8. The vane 6 does not completely close off the slot 8, but a portion of the vane 6 is arranged over the slot 8. The vanes 6 are each curved in a clockwise direction or a counterclockwise direction according to the position of the respective slot 8 with respect to the vane 6. Curved vanes 6 block loss of airflow through the slots 8 from inside the nozzle 4 to outside the nozzle 4, which increases nozzle propulsive efficiency. Curved vanes 6 also create stronger vane vortices, and thus promote near-field mixing while reducing jet noise due to turbulent mixing in the far-field.

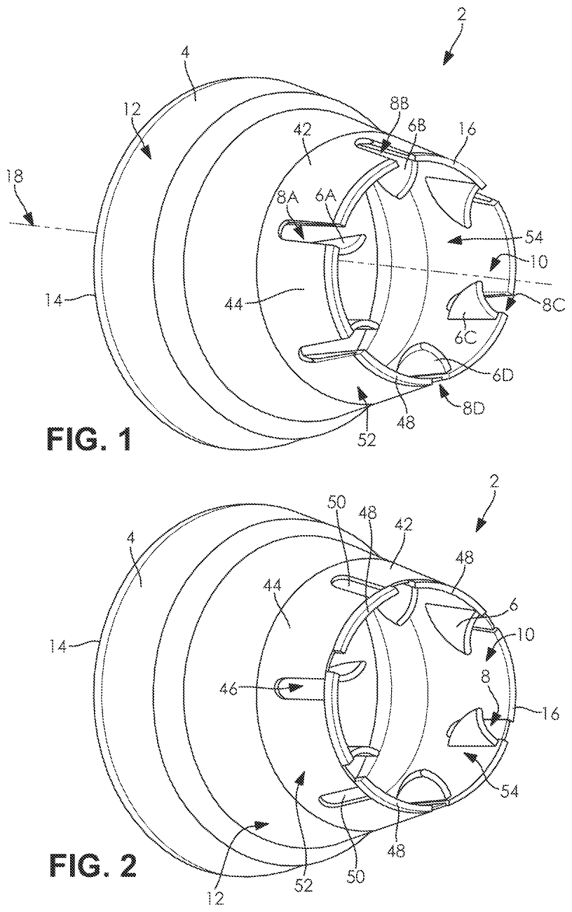

As depicted in FIGS. 1, 2, and 5, adjacent vanes 6 have two slots 8 arranged circumferentially between them or have no slots 8 arranged circumferentially between them. In particular, two adjacent vanes 6A, 6B have two slots 8A, 8B arranged between them (i.e., the two adjacent vanes 6A, 6B are arranged circumferentially outside of the two adjacent slots 8A, 8B), while two other adjacent vanes 6C, 6D have no slots arranged between them (i.e., the two adjacent vanes 6A, 6B are arranged circumferentially between two adjacent slots 8C, 8D). The two adjacent vanes 6A, 6B are curved toward each other in opposite circumferential directions, i.e., vane 6A is curved in a clockwise direction and vane 6B is curved in a counterclockwise direction, so as to partially cover their respective slots 8A, 8B (i.e., vane 6A covers slot 8A and vane 6B covers slot 8B). The other two adjacent vanes 6C, 6D are curved away from each other in opposite circumferential directions. Vane 6C is curved in a clockwise direction while vane 6D is curved in a counterclockwise direction, so as to partially cover their respective slots 8C, 8D. In other words, each vane 6 is curved in the opposite circumferential direction than are the prior and subsequent adjacent vanes around the circumference of the nozzle 4, and each vane 6 is arranged on an opposite side of its respective slot than are the prior and subsequent adjacent vanes around the circumference of the nozzle 4, whereby vane 6C covers slot 8C and vane 6D covers slot 8D.

As depicted in FIG. 4, adjacent vanes 6E, 6F have one slot 8E arranged circumferentially between them, and the vanes 6E, 6F are curved in the same circumferential direction. In particular, each vane 6E, 6F is arranged on the clockwise side of its respective slot 8E, 8F, and is curved in the counterclockwise direction to cover its respective slot 8E, 8F. Alternatively, each vane 6 could be arranged on the counterclockwise side of its respective slot 8 and be curved in the clockwise direction to cover its respective slot 8.

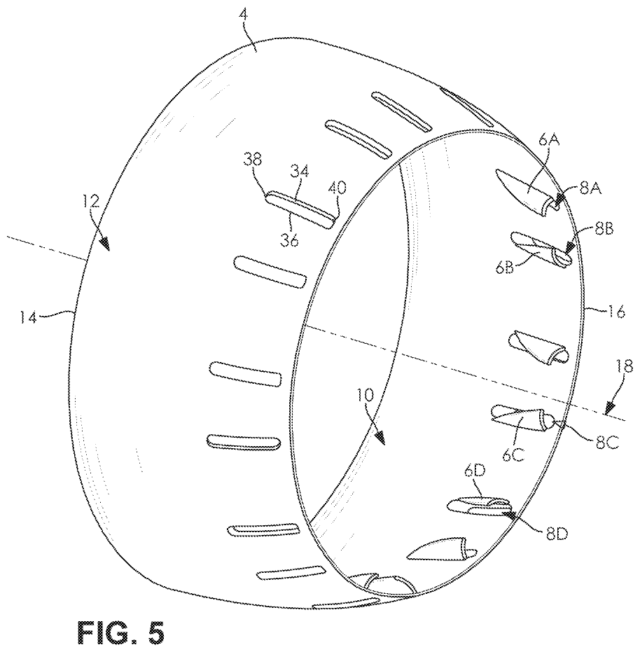

The slots 8 are not particularly limited and may have various shapes and sizes. Each slot 8 is a through hole in the nozzle 4 that completely extends through the thickness of the nozzle 4 from the inner surface 10 to the outer surface 12. Each slot 8 may have a completely closed perimeter (FIG. 5) or may have a closed perimeter except for a downstream opening 32 at its downstream end. Each slot 8 includes two opposite side edges 34, 36 (a clockwise side edge 34 facing the clockwise direction in the figures, and a counterclockwise side edge 36 facing counterclockwise in the figures), an upstream edge 38, and either a downstream edge 40 or a downstream opening 32. One or both of the side edges 34, 36 may run in a straight line parallel with the central axis 18, i.e., may run in a straight line along a radial plane extending from the central axis 18.

Each slot 8 has a length measured from the upstream edge 38 to the downstream edge 40 or to the downstream opening 32 (i.e., to the downstream edge 16 of the nozzle 4), and has a width measured between the two side edges 34, 36. The length of each slot 8 is greater than its maximum width, and the length of the slot 8 may be twice to 100 times the maximum width. The slots 8 may have any shape. In a non-limiting example, each slot 8 has a rounded shape, such as a stadium shape, ellipse shape, parabola shape, oval shape, or parts or combinations thereof. In two non-limiting examples, the slots 8 each have a partial stadium shape with a downstream opening 32 (FIG. 1, 2, 4) or a stadium shape (FIG. 5).

Each slot 8 is positioned at the downstream end of the nozzle 4 near or at the downstream edge 16, and on one side (either clockwise or counterclockwise in the figures) of each of the vanes 6. Each slot 8 may be immediately adjacent to the root 20 of the respective vane 6 with no or little inner surface 10 of the nozzle 4 being visible between the root 20 and the side edge 34 or 36 of slot 8. The root 20 of each vane 6 may run directly into one of the side edges 34, 36 of the respective slot 8. The root 20 of the vane 6 may be parallel to the respective side edge 34 or 36 of the slot 8.

The length of each of the vanes 6 and the length of the respective slot 8 may be coextensive with each other, or one may be shorter or longer than the other. In a non-limiting example, the length of each slot 8 is equal to the length of the respective vane 6. In other words, the vane 6 may extend the entire length of the slot 8. In another non-limiting example, the length of each slot 8 is greater than the length of the respective vane 6. In other words, the vane 6 does not necessarily extend the entire length of the slot 8. In another non-limiting example, the length of each slot 8 is less than the length of the respective vane 6. In other words, the vane 6 extends beyond the length of the slot 8.

The slots 8, when open (FIGS. 1, 4, 5), create a pathway between the nozzle's internal and external gas streams. For unchoked conditions (as expected during takeoff and initial climb for a supersonic commercial aircraft, or during all flight phases for a conventional subsonic jet aircraft), a pressure difference across each slot 8 will tend to draw a small portion of the internal nozzle gas stream outward through the slot 8, called a slot gas stream. This outward flow of the slot gas stream creates a pressure imbalance between opposite side surfaces 28, 30 of the adjacent vanes 6, and the pressure imbalance in turn produces a streamwise vortex, called a vane vortex, off the vane tip 22. Nearby vane vortices—which may be either co-rotating or counter-rotating depending on the circumferential curve of the vanes 6—then interact with each other to create alternating inward and outward gas streams around the circumference of a mixing gas layer that is downstream of the downstream edge 16. Additional trailing vortices are generated at the outer surface 12 along each slot 8 due to the interaction between the external gas stream and slot gas stream. These vortices, referred to here as slot vortices, interact with each other and with neighboring vane vortices to further enhance mixing. As a result of enhanced mixing near the downstream edge 16, the resulting turbulent mixing noise generation—especially at high frequencies—may be concentrated within an area near the downstream edge 16, rather than farther downstream, and thus can be shielded via strategic placement of the engine above a wing or other aircraft component, such as a mixer-ejector shroud. During takeoff and low-altitude flight, when noise reduction is a particular concern, the slots 8 can be fully opened to produce this effect.

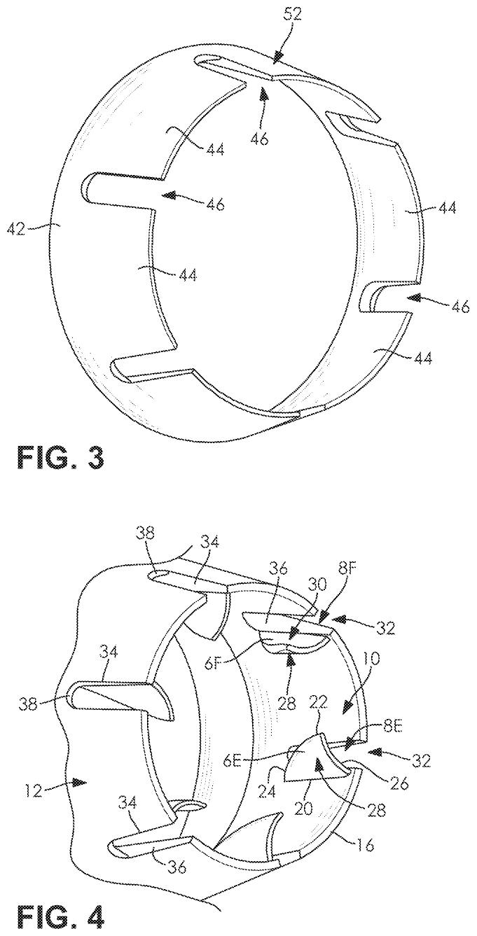

The engine exhaust nozzle 2 may further include a one-piece cover 42 (FIGS. 1-3), which may be used to transition from a takeoff nozzle configuration (FIG. 1, i.e., a first state), where the slots 8 may be fully opened and thus reduce nozzle efficiency and available thrust, to a cruise configuration (FIG. 2, i.e., a second state) where the slots 8 are closed and thus allow increased nozzle efficiency and greater thrust. To accomplish this, the cover 42 may be rotated over a small azimuthal angle about the central axis 18 to cover or close off all the slots 8 so that the slot gas stream is reduced or eliminated, and the entire engine exhaust stream exits through the rear opening 54 of the nozzle 4. And, the cover 42 may be rotated to open all the slots 8 so that the slot gas stream is able to pass through the slots 8 and mix with the external stream or bypass stream surrounding the nozzle 4.

The cover 42 is a slotted ring that is movably attached to the nozzle 4. The cover 42 is movable with respect to the nozzle 4 between a first position (FIG. 1) in which the slots 8 are open and not covered by the cover 42, and a second position (FIG. 2) in which the slots 8 are covered by the cover 42 and thus closed. The cover 42 may move between the first and second positions by being rotated with respect to the nozzle 4 about the central axis 18. The inclusion of the cover 42 in the engine exhaust nozzle 2 makes the device a variable mixing device for the exhaust gas stream through the nozzle 4 and the surrounding bypass or external stream.

The cover 42 is not particularly limited and may have various shapes and configurations for covering and uncovering the slots 8. In a non-limiting example, the cover 42 is a ring including alternating fingers 44 and gaps 46 defined around its circumference. The fingers 44 may extend in a downstream direction from a remainder of the cover 42. When the cover 42 is in the first position (FIG. 1), the gaps 46, which may have the same or a similar size and shape as the slots 8, align with the slots 8 so that the slots 8 are uncovered and open, thus allowing for a free flow of the slot gas stream through the slots 8. When the cover 42 is in the second position (FIG. 2), the fingers 44 align with the slots 8 so that the slots 8 are covered and closed by the fingers 44, thus inhibiting the flow of the slot gas stream through the slots 8.

The cover 42 may be held on the nozzle 4 by a lip 48 of the nozzle 4, such that the tips of the fingers 44 are inhibited from moving downstream by the lip 48 and thus the tips of the fingers 44 are slightly upstream from the downstream edge 16 of the nozzle 4. The cover 42 may be arranged on the outer surface 12 of the nozzle 4, e.g., in an annular trench 50 defined in the outer surface 12 of the nozzle 4. In this way, an outside surface 52 of the cover 42 may be flush with the outer surface 12 of the nozzle 4. Alternatively, the cover 42 may be arranged between the inner and outer surfaces 10, 12 of the nozzle (such as in an internal cavity of the nozzle 4), or even on the inner surface 10 of the nozzle 4.

The cover 42 may thus be rotated a few degrees between the first position where the gaps 46 are each aligned with a respective slot 8 (as during takeoff), and the second position where the gaps 46 are each out of alignment with the respective slot 8 (as during cruise), so as to be able to control (i.e., start and stop) the mass flow rate and degree of pressure equilibration across the slots 8, and thereby vary the strength of vane and slot vortices. It should also be understood that the cover 42 can be controlled to stop at any position somewhere between the first and second position, so as to have the slots 8 only partially closed/open to a desired amount, thus offering a variable mixing of gas streams via the slots 8. The slots 8 can be used for mixing jet exhaust with the surrounding external or bypass stream, as a means to generate vane and slot vortices for enhanced near-field mixing just downstream of the nozzle. This near-field mixing enhancement tends to reduce mixing further downstream (i.e., in the far-field) away from the engine exhaust nozzle 2, thus concentrating the generated turbulent mixing noise in the near-field and reducing it in the far-field. The noise produced in the near-field can then be shielded from the ground by having the engine exhaust nozzle 2 and/or the near-field being arranged directly above an aircraft wing, aircraft tail, or other component, thus shielding the ground from the noise.

A method of making an engine include connecting the engine exhaust nozzle 2 to another component of the engine, e.g., a frame. The engine exhaust nozzle 2 may be attached to a trailing part of the engine so as to eject engine exhaust, e.g., jet efflux, from the engine. The engine exhaust nozzle 2 may be used to mix the jet efflux with bypass air, or with the entire airmass flow around the engine.

A method of making an aircraft includes connecting the engine, including the engine exhaust nozzle 2, to another component of the aircraft, e.g., a wing. The engine may be attached directly above the other component so that sound generated in the near-field is shielded towards the ground below.

A method of operating the aircraft includes operating the jet engine in a first state in which the cover 42 is in the first position and the slots 8 are open; moving the cover 42 relative to the nozzle 4 between the first position and the second position; and operating the jet engine in a second state in which the cover 42 is in the second position and the slots 8 are closed. The cover 42 may be moved automatically by a mechanical device in the engine, on the engine exhaust nozzle, or on the aircraft. The jet engine may be operated for any length of time in the first state, in the second state, and when the cover is between the first and second positions. The jet engine may be operated in the first state when the aircraft is at an altitude below a threshold altitude. The jet engine may be operated in the second state when the aircraft is at an altitude above the threshold altitude. The threshold altitude may be a recognized standard (e.g., a regulation) for aircraft, computed based on jet noise levels, or determined by an operator of the aircraft. Changing operation of the engine between the first state and the second state may be conducted manually such as by human input, or automatically such as by a computer program.

The proposed nozzle configuration is able to provide significant takeoff noise reduction in objectionable frequencies, when used alone or in the presence of mechanical shielding (e.g., using over-wing or over-tail engine placement), and can provide superior acoustic characteristics to a typical chevron nozzle under takeoff conditions. While other conventional alternate nozzle configurations for jet noise reduction have been proposed and show acoustic benefits under similar conditions, the present engine exhaust nozzle provides not only an acoustic benefit, but also the ability to avoid propulsive efficiency penalties during high-altitude flight while avoiding complex variable geometry. In particular, the engine exhaust nozzle 2 includes a simple one-piece rotating cover 42 configuration, which reduces the complexity of the mechanics and construction, yet also is adaptable to reduce noise during takeoff and reduce thrust loss during high-altitude flight. The engine exhaust nozzle 2 employs a single moving part (i.e., the cover 42) to enable or disable its function as a mixing enhancement device. Other typical nozzle designs undesirably have considerable thrust loss at cruise because of non-adjustable sound-reducing means, a mechanism with a very complex variable geometry having a large number of moving parts, and/or an auxiliary gas flow injection mechanism that requires various associated valves and a suitable gas source. The present engine exhaust nozzle 2 thus offers all the benefits of noise reduction, a simple configuration, and maintained efficiency at cruising altitudes.

The engine exhaust nozzle 2 may be used in propulsion system design for commercial or military supersonic aircraft and may be employed to reduce airport noise for subsonic commercial airliners and business jets. The engine exhaust nozzle 2 may be applied to a jet engine and used as either the nacelle trailing edge or as the inner nozzle lip where a mixing layer develops between the core and bypass streams.

The engine exhaust nozzle 2 may be employed as a retrofit device to an existing engine, and may be used, for example, as a small turbofan engine nozzle on a cruise missile or unmanned aerial strike vehicle. The engine exhaust nozzle 2 may then be tuned as desired, by rotating the cover 42 relative to the nozzle 4, to reduce vehicle detectability during low altitude operation in contested airspace, while reducing any resulting impact on range.

It will be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. An engine exhaust nozzle comprising:
a nozzle;
slots arranged at a downstream end of the nozzle, each of the slots extending through a thickness of the nozzle from an inner surface of the nozzle to an outer surface of the nozzle; and
vanes on the inner surface of the nozzle, each of the vanes being arranged at an edge of a respective one of the slots, extending in length along the edge, and projecting from the inner surface towards a central axis of the nozzle.

2. The engine exhaust nozzle according to claim 1, wherein each of the slots have a closed perimeter.

3. The engine exhaust nozzle according to claim 1, wherein each of the slots has a closed perimeter except for a downstream opening.

4. The engine exhaust nozzle according to claim 1, wherein the slots are evenly spaced around a circumference of the nozzle.

5. The engine exhaust nozzle according to claim 1, wherein:
each of the slots includes two side edges, an upstream edge, and either a downstream edge or a downstream opening; and
each of the vanes has a root connected to the inner surface of the of the nozzle and a tip, extends in length along the root from an upstream end of the vane to a downstream end of the vane, and projects in height from the root to the tip.

6. The engine exhaust nozzle according to claim 5, wherein:
each of the vanes includes a leading edge and a trailing edge; and
the leading edge has a positive slope along the length of the vane.

7. The engine exhaust nozzle according to claim 6, wherein each of the vanes is curved along its height in a circumferential direction such that, in a radially inward direction toward the central axis, each of the vanes extends over a respective one of the slots.

8. The engine exhaust nozzle according to claim 7, wherein:
two adjacent vanes are arranged circumferentially between two adjacent slots or the two adjacent vanes are arranged circumferentially outside of the two adjacent slots; and
the two adjacent vanes are each curved in opposite circumferential directions.

9. The engine exhaust nozzle according to claim 7, wherein two adjacent vanes are arranged on circumferentially opposite sides of a respective slot, and the two adjacent vanes are curved in the same circumferential direction.

10. The engine exhaust nozzle according to claim 1, further comprising a cover connected to the nozzle and movable with respect to the nozzle between a first position in which the cover does not cover the slots such that the slots are open, and a second position in which the cover covers the slots such that the slots are closed.

11. The engine exhaust nozzle according to claim 10, wherein:
the cover includes alternating fingers and gaps arranged around a circumference of the cover, the fingers and gaps extending in a downstream direction;
the cover is moveable between the first position and the second position by being rotated around the central axis;
the gaps align with the slots when the cover is in the first position so that the slots are open; and
the fingers align with the slots when the cover is in the second position such that the fingers cover the gaps so that the slots are closed.

12. The engine exhaust nozzle according to claim 10, wherein the nozzle includes an annular trench in the outer surface, and the cover is arranged in the annular trench.

13. A jet engine comprising the engine exhaust nozzle of claim 10, wherein the engine exhaust nozzle ejects exhaust from the jet engine.

14. An aircraft comprising the jet engine of claim 13, wherein the jet engine is attached to a fuselage, a tail, or a wing of the aircraft.

15. The aircraft of claim 14, wherein the engine exhaust nozzle is arranged directly above the fuselage, the tail, or the wing.

16. A method of operating the aircraft of claim 14, comprising:
operating the jet engine in a first state in which the cover is in the first position and the slots are open;
moving the cover between the first position and the second position; and
operating the jet engine in a second state in which the cover is in the second position and the slots are closed.

17. The method of claim 16, wherein:
the jet engine is operated in the first state when the aircraft is at an altitude below a threshold altitude; and
the jet engine is operated in the second state when the aircraft is at an altitude above the threshold altitude.

18. A method of making a jet engine comprising attaching the engine exhaust nozzle of claim 10 to the jet engine.

19. A method of making an aircraft, comprising attaching the jet engine of claim 18 to the aircraft.

20. The method of claim 19, wherein the engine exhaust nozzle is arranged directly above another component of the aircraft.
